(19) United States
(12) Patent Application Publication
(10) Pub. No.: US 2016/0264100 A1
(43) Pub. Date: Sep. 15, 2016

(54) POSITIVE TEMPERATURE COEFFICIENT HEATING ASSEMBLY AND DEFROSTER FOR A VEHICLE

(71) Applicant: BYD COMPANY LIMITED, Shenzhen, Guangdong (CN)

(72) Inventors: QING GONG, Shenzhen (CN); XINPING LIN, Shenzhen (CN); HUI WU, Shenzhen (CN); XIAOFANG LI, Shenzhen (CN); MAOLIN REN, Shenzhen (CN); SHUMIN WANG, Shenzhen (CN); MENGXIANG WU, Shenzhen (CN); TIANYOU DENG, Shenzhen (CN); HUAITONG WEN, Shenzhen (CN); WEIFENG ZHANG, Shenzhen (CN); HONGMEI QIU, Shenzhen (CN)

(21) Appl. No.: 15/028,969

(22) PCT Filed: Oct. 22, 2014
(86) PCT No.: PCT/CN2014/089164

§ 371 Date: Apr. 13, 2016

(30) Foreign Application Priority Data
Oct. 22, 2013 (CN) 201310499319.9
Oct. 22, 2013 (CN) 201320652871.2

(51) Int. Cl. B60S 1/02; H05B 3/40; H05B 3/14

(52) U.S. Cl. CPC B60S 1/026; H05B 3/141; H05B 3/40

(57) ABSTRACT

A positive temperature coefficient heating assembly includes a heating core including a first metal electrode plate, a second metal electrode plate and a plurality of PTC ceramic chips; an insulating layer coated on the heating core; and a metal tube; the PTC ceramic chip includes a positive electrode layer, a negative electrode layer, and a ceramic sintered layer; a plurality of first limit grooves are formed in the first metal electrode plate, a plurality of second limit grooves are formed in the second metal electrode plate, a first end of each of the PTC ceramic chips is embedded in one of the first limit grooves, and a second end of each of the PTC ceramic chips is embedded in one of the second limit grooves.

### CROSS-REFERENCE TO RELATED APPLICATION

This application claims the priority to and benefits of the following applications: 1) Chinese Patent Application No. 201310499319.9 filed with the State Intellectual Property Office of the People's Republic of China (SIPO) on Oct. 22, 2013; and 2) Chinese Patent Application No. 201320652871.2 filed with the State Intellectual Property Office of the People's Republic of China (SIPO) on Oct. 22, 2013. The above enumerated patent applications are incorporated by reference herein in their entirety.

### FIELD

Exemplary embodiments of the present disclosure generally relate generally to a heating field and, more particularly, to a positive temperature coefficient heating assembly and a defroster for a vehicle.

### BACKGROUND

Positive temperature coefficient (PTC) heater has been widely used in heating applications, and there are various types of PTC heaters, because that the PTC heater has a short heating time and a less influence affected by a fluctuation of a supply voltage. The PTC heater has become an optimal replacement of metal resistance heating material. At present, thus, the PTC heater has been applied in a large scale in applications such as warmer, clothes dryer, wind curtain machine, air-condition, etc.

In the related art, a PTC heater generally includes a heating core, an insulating layer, a metal tube and a cooling fin, in which, the heating core is cladded by the insulating layer and disposed inside the metal tube, and both ends of the metal tube are open and sealed with sealing rubber. The cooling fin is attached on the surface of the metal tube. The heating core generally includes two metal electrode plates and a plurality of PTC ceramic chips between the two metal electrode plates. A conductive adhesive layer, such as high-temperature silicone rubber, is usually disposed between the metal electrode plate and the PTC ceramic chip to electrically connect the metal electrode plate with the PTC ceramic chip. Such PTC heater has a remarkable increase in waterproofness, insulativity and pressure-resistance. But with a conductive adhesive layer disposed between the metal electrode plate and the PTC ceramic chip, the impedance of the PTC ceramic chip is increased. In addition, when the PTC heater is electrified with a high voltage, the performance of the high-temperature silicone rubber is reduced dramatically due to aging of the high-temperature silicone rubber, thus increasing an effect of insulation resistance, a probability of poor contact and a risk of breakdown.

### SUMMARY

Embodiments of the present disclosure seek to solve at least one of the problems existing in the related art to at least some extent.

Embodiments of a first broad aspect of the present disclosure provide a positive temperature coefficient heating assembly.

Embodiments of a second broad aspect of the present disclosure provide a defroster for a vehicle.

Embodiments of the present disclosure provide a positive temperature coefficient heating assembly. The positive temperature coefficient heating assembly includes a heating core including a first metal electrode plate, a second metal electrode plate and a plurality of PTC ceramic chips between the first and second metal electrode plates; an insulating layer coated on the heating core; and a metal tube accommodating the heating core and the insulating layer therein; the PTC ceramic chip includes a positive electrode layer, a negative electrode layer, and a ceramic sintered layer between the positive electrode layer and the negative electrode layer; a plurality of first limit grooves are formed in the first metal electrode plate and correspond to the PTC ceramic chips, a plurality of second limit grooves are formed in the second metal electrode plate and correspond to the PTC ceramic chips, a first end of each of the PTC ceramic chips is embedded in one of the first limit grooves, and a second end of each of the PTC ceramic chips is embedded in one of the second limit grooves, so that the first and second metal electrode plates are electrically connected with the positive and the negative electrode layers of the PTC ceramic chip respectively.

According to the positive temperature coefficient heating assembly of the present disclosure, the conductive adhesive in the related art is replaced by a direct connection between a plurality of limit grooves and the PTC ceramic chips. The limit grooves are formed in the first and second metal electrode plates and correspond to the PTC ceramic chips, and two ends of each the PTC ceramic chips is embedded into the first and second limit grooves respectively, so that the two metal electrode plates are electrically connected with the positive and the negative electrode layers of the PTC ceramic chip respectively. A directly electrical connection between the metal electrode plate and the PTC ceramic chip is obtained. Therefore, the negative influences brought by the conductive adhesive are eliminated, thus, an aging problem of the conductive adhesive (such as performance degradation) is avoided, an insulation resistance is reduced, and a probability of poor contact and a risk of breakdown are greatly reduced. Meanwhile, a thermal conductivity of the PTC ceramic 1 chip can be improved, an insulating pressure-resistant property of the whole PTC heating assembly can also be enhanced, and the PTC heating assembly of the present disclosure can be safer and low in cost.

In some embodiments of the present disclosure, a boss is disposed on each of two biggest surfaces of the ceramic sintered layer and the positive and the negative electrode layers are disposed on the boss respectively.

In some embodiments of the present disclosure, a height of the boss is from 0.2 mm to 0.5 mm, and distances between the edges of the boss and edges of the biggest surface of the PTC ceramic chip are equal ranges from 0.5 mm to 3 mm.

In some embodiments of the present disclosure, the metal tube defines two open ends sealed with a sealing material, a leading-out terminal is disposed at at least one end of the first and second metal electrode plates and is extended out of the metal tube from the open end.

In some embodiments of the present disclosure, the PTC ceramic chip has a thickness of about 3.0 mm to about 4.0 mm, and the limit groove has a depth of about 0.15 mm to about 0.45 mm.

In some embodiments of the present disclosure, the metal electrode plate is treated with a roughening treatment, and a roughness of the metal electrode plate is from 4 μm to 10 μm.

In some embodiments of the present disclosure, the metal electrode plate is a brass slice.

In some embodiments of the present disclosure, a cooling fin is attached on a surface of the metal tube.

In some embodiments of the present disclosure, the positive temperature coefficient heating assembly further includes two supports, and the metal tube is configured to be supported by the two supports.

In some embodiments of the present disclosure, the two supports include a temperature fuse and a temperature controller.

Embodiment of the present disclosure provides a defroster for a vehicle including a positive temperature coefficient heating assembly.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a perspective view of a positive temperature coefficient heating assembly according to an embodiment of the present disclosure;

FIG. 2 is a top view of a positive temperature coefficient heating assembly according to an embodiment of the present disclosure;

FIG. 3 is an enlarged view of the part A in FIG. 2;

FIG. 4 is a front view of a positive temperature coefficient heating assembly according to an embodiment of the present disclosure;

FIG. 5 is an enlarged view of the part B in FIG. 4;

FIG. 6 is a top view of a metal electrode plate of a positive temperature coefficient heating assembly according to an embodiment of the present disclosure;

FIG. 7 is a front view of a metal electrode plate of a positive temperature coefficient heating assembly according to an embodiment of the present disclosure;

FIG. 8 is an enlarged view of the part C in FIG. 7;

FIG. 9 is an exploded view of a heating core of a positive temperature coefficient heating assembly according to an embodiment of the present disclosure;

FIG. 10 is an enlarged view of the part D in FIG. 9;

FIG. 11 is a sectional view of a heating core of a positive temperature coefficient heating assembly according to an embodiment of the present disclosure;

FIG. 12 an enlarged view of the part E in FIG. 11;

FIG. 13 is a sectional view of a positive temperature coefficient heating assembly according to an embodiment of the present disclosure;

FIG. 14 is an enlarged view of the part F in FIG. 13.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

It is to be understood that phraseology and terminology used herein with reference to device or element orientation (such as, terms like “longitudinal”, “lateral”, “up”, “down”, “front”, “rear”, “left”, “right”, “vertical”, “horizontal”, “top”, “bottom”, “inside”, “outside”) are only used to simplify description of the present disclosure, and do not indicate or imply that the device or element referred to must have or operated in a particular orientation. They cannot be seen as limits to the present disclosure.

In the description, terms such as “first” and “second” are used herein for purposes of description and are not intended to indicate or imply relative importance or significance. In addition, for the purpose of the present description and of the following claims, the definitions of the numerical ranges always include the extremes unless otherwise specified.

In the description, terms concerning attachments, coupling and the like, such as “connected” and “interconnected”, refer to a relationship in which structures are secured or attached to one another through mechanical or electrical connection, or directly or indirectly through intervening structures, unless expressly described otherwise. Specific implications of the above phraseology and terminology may be understood by those skilled in the art according to specific situations.

### First Embodiment

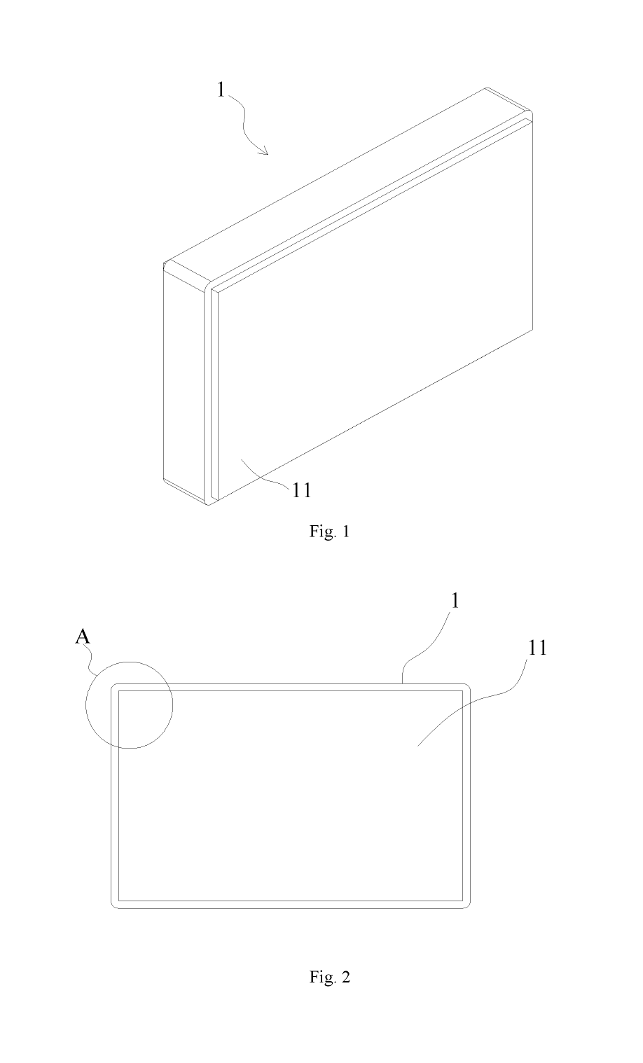

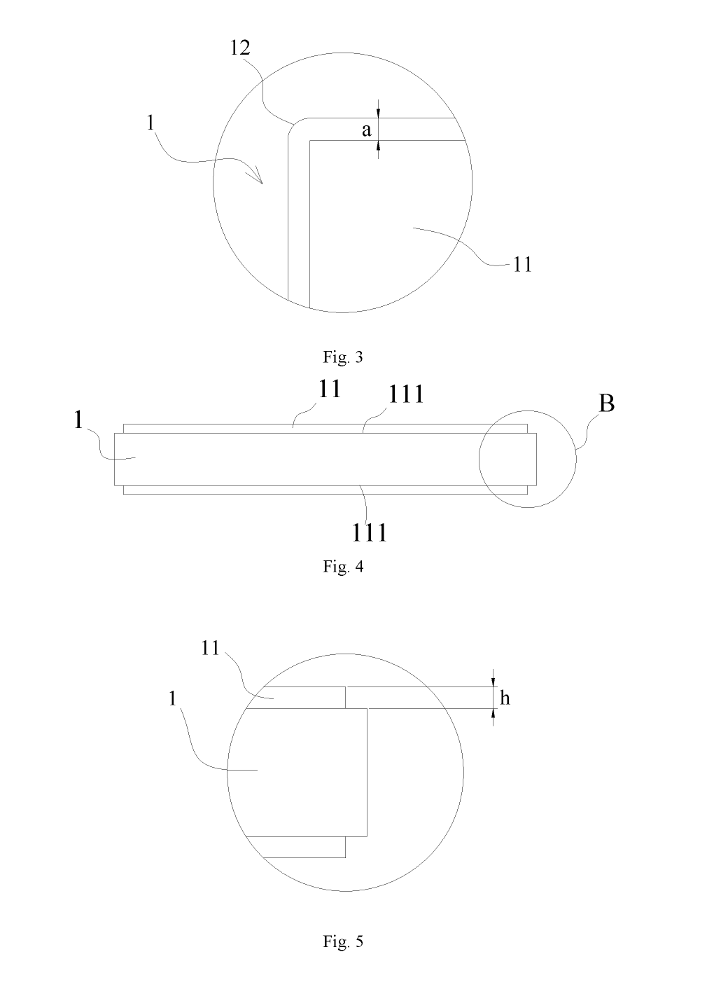

The PTC heating assembly according to an embodiment of the present disclosure will be described below with reference to FIGS. 1-14.

In the related art, a conductive rubber is disposed between the metal electrode plate and the PTC ceramic chip, which may cause a performance degradation of the PTC heating assembly, an increase of insulation impedance, a poor contact and a breakdown. According to the first embodiment, a positive temperature coefficient heating assembly is provided.

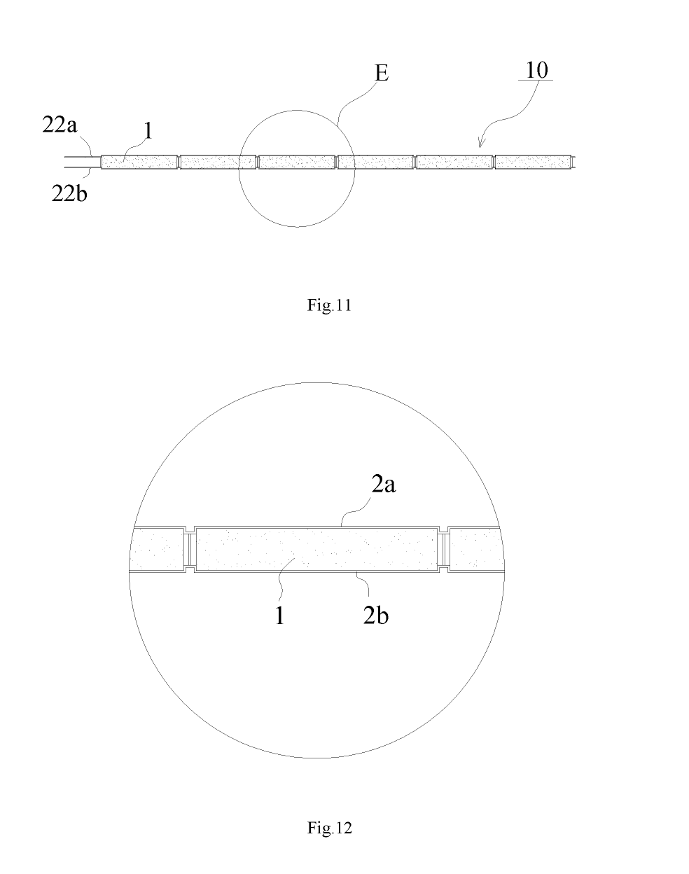

As shown in FIGS. 12-14, the PTC heating assembly includes a heating core 10, a metal tube 8 and an insulating layer 9 coated on the heating core.

The metal tube 8 accommodates the heating core 10 and the insulating layer 9. The heating core 10 includes a metal electrode plate 2 and a plurality of PTC ceramic chips 1. The metal electrode plate 2 includes a first metal electrode plate 2a and a second metal electrode plate 2b. The PTC ceramic chip 1 includes a positive electrode layer, a negative electrode layer and a ceramic sintered layer between the positive and negative electrode layers.

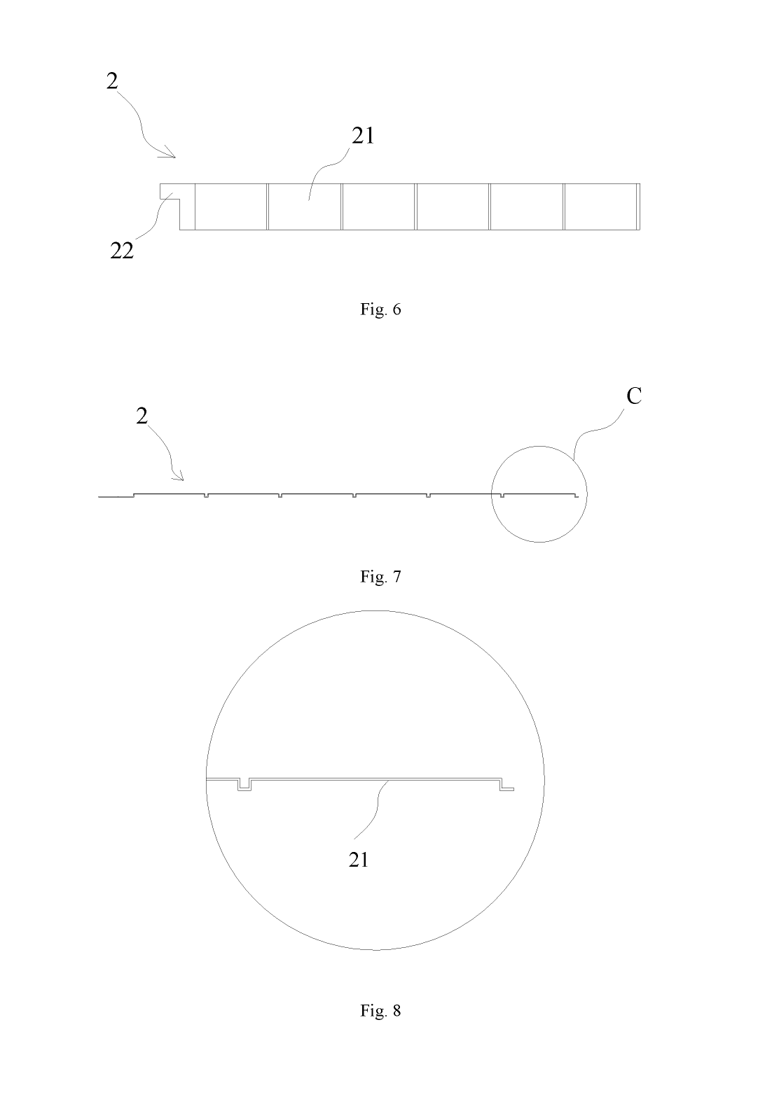

As shown in FIGS. 6-10, a plurality of limit grooves 21 are disposed in the two metal electrode plates 2 and correspond to the PTC ceramic chips 1, in other words, a plurality of first limit grooves 21a are formed in the first metal electrode plate 2a and each of the first limit grooves 21a is aligned with one relative PTC ceramic chip 1, a plurality of second limit grooves 21b are formed in the second metal electrode plate 2b and each of the second limit grooves 21a is aligned with one relative PTC ceramic chips 1. With the such structure of the two metal electrode plates 21, a first end of each of the PTC ceramic chips 1 can be embedded in the relative first limit groove 21a, and a second end of each of the PTC ceramic chips 1 can be embedded in the relative second limit groove 21b, so that the first and second metal electrode plates 21a, 21b are electrically connected with the positive and the negative electrode layers of the PTC ceramic chip 1 respectively.

According to the present disclosure, the conductive adhesive in the related art is replaced by the direct connection between the plurality of limit grooves 21 of the two metal electrode plates 2 and the PTC ceramic chip 1, so that the directly electrical connection between the metal electrode plate 2 and the PTC ceramic chip 1 can be obtained. Therefore, the negative influences brought by the conductive adhesive layer are eliminated, thus, an aging problem of the conductive adhesive, such as a performance degradation, is avoided, an insulation resistance is reduced, and a probability of poor contact and a risk of breakdown are greatly reduced. Meanwhile, a thermal conductivity of the PTC ceramic 1 can be improved, an insulating pressure-resistant property of the whole PTC heating assembly can also be enhanced, and the PTC heating assembly of the present disclosure can be safer and low in cost.

The heating core 10 and the insulating layer 9 coated on the heating core 10 can be configured as one integral member to be inserted and accommodated into the metal tube 8.

In some embodiments, the metal tube 8 may be an aluminum square tube with two open ends. There are no particular limits for the metal tube 8 in the present disclosure, as long as the metal tube has a good heat conduction.

The PTC ceramic plate 1 may be adopted those commonly-used PTC ceramic plates in the related art, the PTC ceramic plate may have a sandwich structure where the ceramic sintered layer is disposed in the middle. The ceramic sintered layer is formed by sintering PTC ceramic material, such as BaTiO3 series PTC ceramic material and/or V2O3 series PTC ceramic material.

Steps of a general process of the above sintering includes mixing PTC ceramic material with binder to form a mixture; pre-sintering the mixture to obtain a powder; ball-milling the power, then pressing, molding and sintering the powder at a high temperature to form a ceramic sintered layer.

A positive and a negative electrode layers are formed on the two biggest surfaces 111 (the surfaces with the biggest area) of the ceramic sintered layer respectively by spraying or sputtering. The positive and the negative electrode layers may include an aluminum layer or silver layer and have a very thin thickness with about 20 μm to 30 μm. The total thickness of the PTC ceramic plate 1 is about 2.0 mm to 4.0 mm.

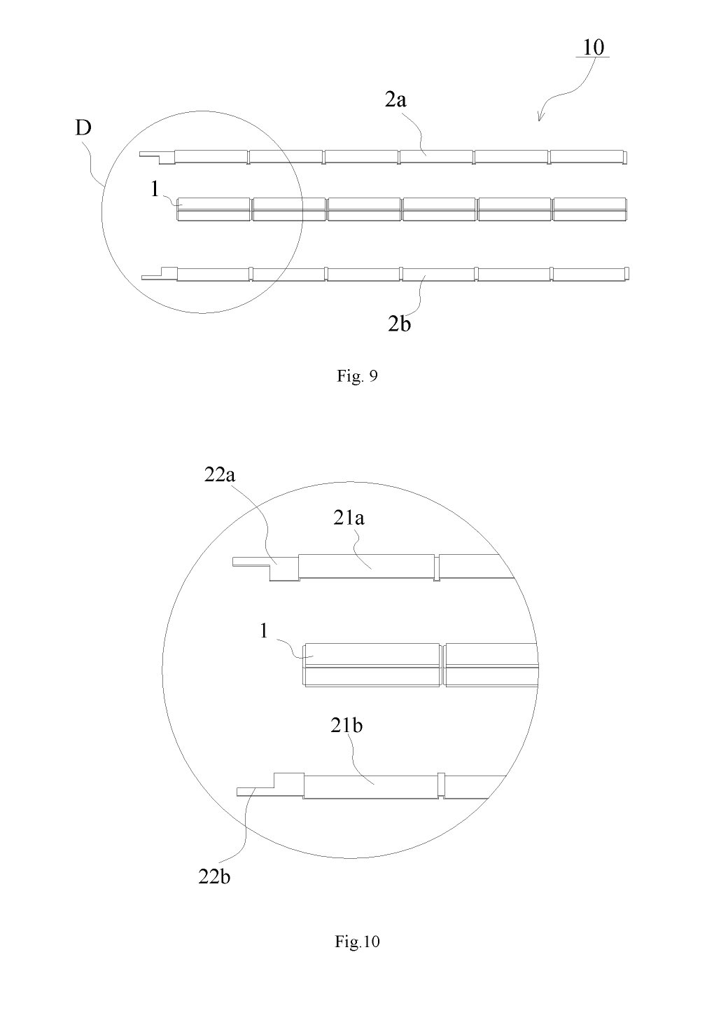

Generally, a PTC heating assembly has a plurality of PTC ceramic plates 1, as shown in FIG. 9, the PTC heating assembly has 6 PTC ceramic plates 1. There are no particular limitations for the number of the PTC ceramic plates 1, which depends on an actual requirement.

As shown in FIGS. 6-8, the numbers of the limit grooves 21 formed in each of the first and second metal electrode plates 2a and 2b are same and equal to that of the PTC ceramic chips. For example, if there are 6 PTC ceramic chips, correspondingly, the first metal electrode plate 2a has 6 limit grooves 21a, and second metal electrode plate 2b has 6 limit grooves 21b as well, so that the metal electrode plate 2 is configured as a square wave with a very large duty ratio. The limit grooves 21 may be formed by stamping the metal electrode plate 2.

Meanwhile, a leading-out terminal 22 is disposed at least one end of the metal electrode plate 2. As shown in FIG. 6, the leading-out terminal 22 is configured to have an L-shape and is used to electrically connect to an exterior of the heating core 10. Generally, the mental tube 8 defines two open ends sealed with sealing materials, and the leading-out terminal 22 is extended out of the metal tube from the open end, i.e. the leading-out terminal 22 passes through the metal tube 8 and penetrates the sealing material.

In some embodiments, a waterproof silica gel may be used as the sealing material. Therefore, the heating core 10 can be sealed inside the metal tube 8, and the leading-out terminal 22 may be extended only from one or two open ends of the metal tube 8, i.e., the leading-out terminal 22 is the only portion exposed outside the metal tube 8. Therefore, the PTC heating assembly can have an improved insulating pressure-resistant, an excellent waterproofness and the better safety performance, due to sealing the open end from which the leading-out terminal 22 extends with the sealing material.

A thickness of each the first and second metal electrode plates 2a and 2b is from 0.15 mm to 0.30 mm, and a depth of each the first and second limit grooves 21a and 21b is from 0.15 mm to 0.45 mm.

Each of the first and second metal electrode plate 2a and 2b is an aluminum sheet or a latten, preferably is the latten with a relative low resistance. The first and second metal electrode plate 2a and 2b are metal plates treated by roughening, with a roughness of 4 μm to 10 μm. Therefore, the electrical connection between the PTC ceramic chip 1 and the metal electrode plate 2 can be more stable. The said treatment of roughening may be a process of polishing with an abrasive paper or a sander.

As shown in FIGS. 9-10, the leading-out terminal 22 includes a first electrode leading-out terminal 22a disposed at the first electrode plate 2a and a second electrode leading-out terminal 22b disposed at the second electrode plate 2b. Therefore, each PTC ceramic chip 1 is embedded and fixed between the first limit groove 21a in the first electrode plate 2a and the second limit groove 21b in the second electrode plate 2b. The heating core 10 is coated with an insulating layer 9, and both the heating core 10 and the insulating layer 9 integrally disposed inside of the metal tube 8. Subsequently, the metal tube 8 is treated by pressing, thus enhancing the stability of the electrical connection between the metal electrode plate 2 and the PTC ceramic chip 1, avoiding a poor contact and ensuring a safe and reliable electrical connection.

The insulating layer 9 may be a high temperature silica gasket or an alumina ceramic, etc. There's no special limit to the insulating layer 9, as long as with good insulation and heat conduction.

As shown in FIGS. 1-5, in some embodiments, a boss 11 is disposed on each of the biggest surfaces 111 of the ceramic sintered layer and the positive and the negative electrode layers are disposed on the boss 11 respectively. In FIG. 4, the two biggest surfaces 111 refer to the upper and lower surfaces. The other four surfaces of the ceramic sintered layer adjacent to the biggest surface 111 are side surfaces.

A positive and negative electrode layers are formed on the outer surfaces of the bosses 11 respectively by spraying or sputtering. Moreover, a positive and a negative electrode layers may be formed on the rest surfaces of the bosses 11 by spraying or sputtering.

A height of the boss is from 0.2 mm to 0.5 mm, and distances between the edges of the boss 21 and the edges of the biggest surface 111 of the PTC ceramic chip 1 range from 0.5 mm to 3 mm. In some embodiments of the present disclosure, the boss 21 may be formed at a central region of each the biggest surface 111, so that the distances between the edges of the boss 21 and the edges of the biggest surface are equal and range from 0.5 mm to 3 mm as well. The four angles of the PTC ceramic chips 1 may be round off.

The PTC ceramic chip 1 with the boss 11 may be embedded in the limit groove 21 more easily, and the electrical connection between the PTC ceramic chip 1 and the limit groove 21 may be more stable.

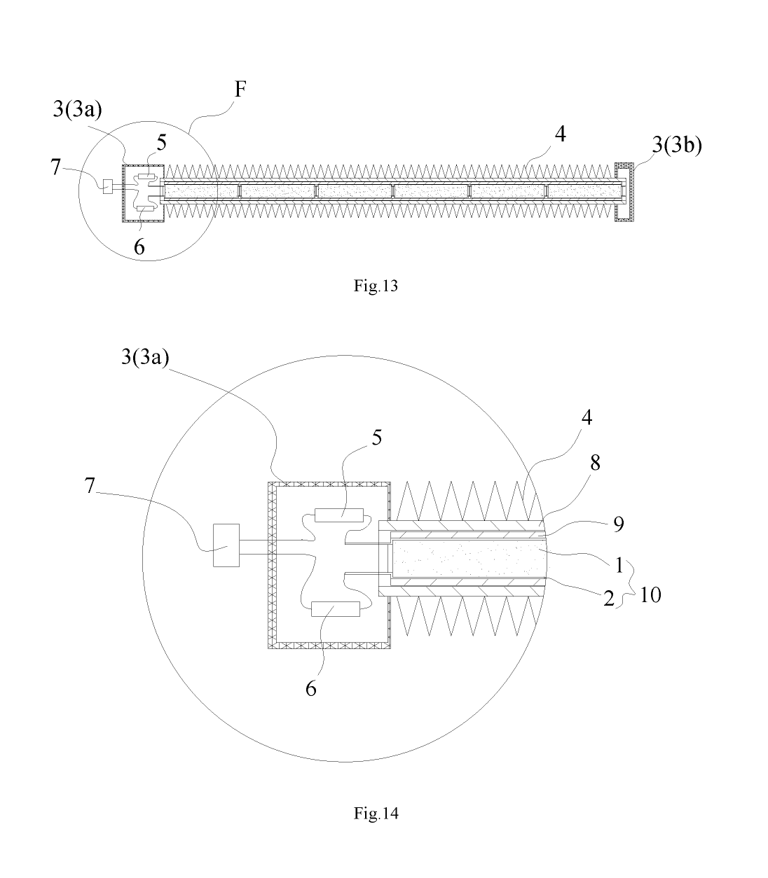

As shown in FIGS. 13-14, in some embodiments, a cooling fin 4 is attached on an outer surface of the metal tube 8, and the cooling fin 4 may be one wavy member or formed by combining a plurality of W-shaped or V-shaped fins. The material of the cooling fin may be aluminum. The cooling fin 4 may be attached on the outer surface of the metal tube 8 with a silicone rubber.

As shown in FIGS. 13-14, the PTC heating assembly further includes two supports, and the metal tube accommodating the PTC ceramic chip 1 and the insulating layer are configured to be supported by the two supports. In FIG. 13, the support 3 at left is referred as a left support 3a, and the support 3 at right is referred as a right support 3b, so that two ends of the metal tube 8 are supported by the two supports respectively. The support 3 may have a cavity, and the two ends of the sealed metal tube 8 may be inserted into the cavities respectively, so as to seal the two ends of the PTC heating assembly. In the process of sealing, a sealant may be filled inside the cavity.

The support 3 of the PTC heating assembly further includes a temperature fuse and a temperature controller. As shown in FIGS. 13-14, the temperature fuse 5 and the temperature controller 6 are arranged in the left support 3a which is adjacent to the first electrode leading-out terminal 22a and the second electrode leading-out terminal 22b, so that the temperature fuse 5 and the temperature controller 6 are adapted to connect to the first electrode leading-out terminal 22a and the second electrode leading-out terminal 22b respectively, and then the first electrode leading-out terminal 22a and the second electrode leading-out terminal 22b are connected with a wire which has a plug 7 connected with the power supply.

The preparation process of the PTC heating assembly includes the following steps.

Step 1, the PTC ceramic chip 1 with a boss 11 is prepared, and an electrode metal plate is stamped to form a plurality of limit grooves 21 corresponding to the PTC ceramic chips 1; step 2, the electrode metal plates are roughened and the PTC ceramic plates are embedded between the two roughened electrode metal plates to form a heating core 10; step 3, the heating core 10 is coated with an insulating layer 9, and the coated heating core 10 is inserted into the metal tube 8, and then the metal tube 8 is pressed by a pressing machine; step 4, a cooling fin 4 screen printed with a high temperature silicone rubber is attached onto the metal tube 8, and then the metal tube is cured and sealed with a waterproof glue; step 5, a support 3 is installed at each end of the metal tube 8, and a temperature fuse and a temperature controller are installed inside the support and connected with the wire.

As described above, with the direct connection between the limit groove and the PTC ceramic chip, the negative influences brought by the conductive adhesive layer are eliminated, the electrical connections of the PTC heating assembly is more reliable, the thermal conductivity of the PTC heating assembly can be improved, and the cost can be reduced. Moreover, an insulating pressure-resistant property of the whole PTC heating assembly can also be improved, and the safety of the PTC heating assembly is ensured.

### Second Embodiment

The defroster for a vehicle according to an embodiment of the present disclosure will be described below with reference to the drawings.

A defroster for a vehicle is provided, and the defroster is mainly applied in the windshield of the vehicle to defrost by heating the air when the windshield is covered with frost. The defroster generally includes components such as a draught fan, a heater and a defrost channel. An operation process of the defroster in the related art includes that: air from the draught fan is transferred to the defrost channel through the heater, and then transferred uniformly to the inner side of the windshield through the defrost channel to perform a defrosting or demisting. The main improvement of the defroster of the present disclosure is that the heater of the defroster adopts the PTC heating assembly of the present disclosure. The other components of the defroster and the connection relationship are known to those skilled in the art, thus details related are omitted herein.

As described above, with the direct connection between the limit groove and the PTC ceramic chip, the negative influences brought by the conductive adhesive layer are eliminated, the electrical connections of the PTC heating assembly is more reliable, the thermal conductivity of the PTC heating assembly can be improved, and the cost can be decreased. Moreover, the insulating pressure-resistant property of the whole PTC heating assembly can also be improved, and the PTC heating assembly is safer.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A positive temperature coefficient heating assembly, comprising:
a heating core comprising a first metal electrode plate, a second metal electrode plate and a plurality of PTC ceramic chips between the first and second metal electrode plates;
an insulating layer coated on the heating core; and
a metal tube accommodating the heating core and the insulating layer,
wherein the PTC ceramic chip comprises a positive electrode layer, a negative electrode layer, and a ceramic sintered layer between the positive electrode layer and the negative electrode layer;
a plurality of first limit grooves are formed in the first metal electrode plate and correspond to the PTC ceramic chips, a plurality of second limit grooves are formed in the second metal electrode plate and correspond to the PTC ceramic chips, a first end of each of the PTC ceramic chips is embedded in one of the first limit grooves, and a second end of each of the PTC ceramic chips is embedded in one of the second limit grooves, so that the first and second metal electrode plates are electrically connected with the positive and the negative electrode layers of the PTC ceramic chip respectively.

2. The positive temperature coefficient heating assembly of claim 1, wherein a lug boss is disposed on each of two biggest surfaces of the ceramic sintered layer and the positive and the negative electrode layers are disposed on the boss respectively.

3. The positive temperature coefficient heating assembly of claim 2, wherein a height of the boss is from 0.2 mm to 0.5 mm, and distances between the edges of the boss and edges of the biggest surface of the PTC ceramic chip range from 0.5 mm to 3 mm.

4. The positive temperature coefficient heating assembly of claim 1, wherein the metal tube defines two open ends sealed with a sealing material, a leading-out terminal is disposed at least one end of the first and second metal electrode plates and is extended out of the metal tube from the open end.

5. The positive temperature coefficient heating assembly of claim 1, wherein the PTC ceramic chip has a thickness of about 3.0 mm to about 4.0 mm, and the limit groove has a depth of about 0.15 mm to about 0.45 mm.

6. The positive temperature coefficient heating assembly of claim 1, wherein the metal electrode plate is treated with a roughening treatment, and a roughness of the metal electrode plate is from 4 μm to 10 μm.

7. The positive temperature coefficient heating assembly of claim 6, wherein the metal electrode plate is a brass slice.

8. The positive temperature coefficient heating assembly of claim 1, wherein a cooling fin is attached on a surface of the metal tube.

9. The positive temperature coefficient heating assembly of claim 1, further comprising two supports, and the metal tube is configured to be supported by the two supports.

10. The positive temperature coefficient heating assembly of claim 9, wherein the two supports comprise a temperature fuse and a temperature controller.

11. A defroster for a vehicle, comprising a positive temperature coefficient heating assembly according to claim 1.
